(19) United States
(12) Patent Application Publication
(10) Pub. No.: US 2005/0188351 A1
(43) Pub. Date: Aug. 25, 2005

(54) Device and method for automatically generating automation software

(75) Inventors: Werner Hoefler, Eckental (DE); Michael Tiegelkamp, Pyrbaum (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/956,074

(22) Filed: Oct. 4, 2004

Related U.S. Application Data
(63) Continuation of application No. PCT/DE03/01091, filed on Apr. 2, 2003.

(30) Foreign Application Priority Data
Apr. 2, 2002 (DE) 10214553.9

(51) Int. Cl. G06F 9/44

(52) U.S. Cl. 717/106

(57) ABSTRACT

A device and a method for automatically generating automation software, having a generator (10) that includes at least one software generator (11) and a project generator (12). A development environment (14) is generated by the software generator (11) by using first data, particularly planning data (17), program knowledge (18) and administration knowledge (19), and control software (15) can be generated with the project generator (12), using the development environment (14) and using second data, particularly planning data (17), experimental data (20), and hardware knowledge (21).

This is a Continuation of International Application PCT/DE03/01091, with an international filing date of Apr. 2, 2003, which was published under PCT Article 21(2) in German, and the disclosure of which is incorporated into this application by reference.

### FIELD AND BACKGROUND OF THE INVENTION

1. Field of the Invention

The present invention relates to a device and a method for automatically generating automation software or parts and, in particular, for automatically generating the structures of automation software or parts of the automation software.

2. Description of Related Art

International Application PCT/DE03/00511 (corresponding to German Application 102 06 691.4) discloses a method for the use of at least one service, which is stored in a computer memory, by a user. Service is defined as providing software corresponding to the specifications of the user. The user logs onto an administrative unit that monitors access to the service and specifies the desired service. In response, the administrative unit determines the individual components required to call up a service corresponding to the specifications of the service and generates the software from these components. In addition, the administrative unit generates an entry for each required component in a license data record assigned to the user in a license database.

Moreover, German Application 102 09 640 discloses a method for generating an automation program from an HMI program (HMI=Human Machine Interface) using a generator. The generator recognizes structures of the FMI program and converts them into structures of the automation program.

### OBJECTS OF THE INVENTION

One object of the present invention is to provide a device and a method for simplifying the processes involved in generating automation software or parts thereof.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to an exemplary, non-limiting embodiment of the present invention, a device for automatically generating automation software is provided. The device has a generator that includes at least one software generator and a project generator. The software generator is used to generate a development environment using first data, for example, planning data, program knowledge and administration knowledge. Using this generated development environment and second data, such as planning data, experience data and hardware knowledge, the project generator generates control software.

According to another exemplary, non-limiting embodiment of the present invention, a method for automatically generating automation software using a generator is provided. The generator has one or more software generators and a project generator. In this illustrative method, the software generator generates a development environment using first data and the project generator generates control software using the development environment and second data.

According to yet another exemplary, non-limiting embodiment of the present invention, a system for automatically generating automation software is provided. The system has a preprocessor that processes input data and data specified in a data store. The specified data has first data and second data. In addition, the system has a software generator generating a development environment based on the first data received from the preprocessor. Further, the system has a project generator generating a control software based on the development environment generated by the software generator and the second data received from the preprocessor.

The exemplary, non-limiting embodiments of the present invention are based on recognition that further development of software is related to additional features that enable the user to solve the actual problem more easily and/or more quickly. With the exemplary, non-limiting embodiments, it is sought to analyze the problem and provide a way to automatically generate automation software for an optimized solution to that problem.

The current solutions available for accessing a wide variety of types of data are used in the exemplary process. Powerful search algorithms, which are used, for example, in the Internet, allow for searching large data stocks with respect to specified or default key data, which occurs, for example, in the description of a problem by keywords, e.g., “brewery,” “steel rolling mill,” etc.

In addition, there is a trend towards the use of standardized interfaces. These interfaces enable, e.g., the further processing of CAD data, such that the CAD data and library information that is linked to individual data records of the CAD data can be used to determine all of the components of a technical process to be automated, e.g., motors, valves, limit switches, etc.

By using default or specified rules, each component can be assigned, e.g., to the category of actuators or the category of sensors. For each actuator a suitable number of outputs of an automation hardware device and, correspondingly, for each sensor, a suitable number of inputs are provided. As a result, the data volume to be processed is already roughly established and, in particular, a central automation device can be automatically selected based on criteria such as computing capacity and memory capacity.

In contrast, related techniques generate automation software using commercially available standard development environments. These standard development environments provide a number of ready-made functions and services without being able to take into account the individual needs of each user. According to the exemplary, non-limiting embodiments of the present invention, an individual development environment for automatically generating automation software, or parts, in particular, structures thereof, must first be generated. Thereafter, this individually generated development environment is used to generate control software.

The control software is an automation software that controls and/or monitors a specific technical process, e.g., a production line, such as a roll stand or a series of component insertion machines and may include graphic user guidance, e.g., by means of a control and monitoring system or a human machine interface (HMI).

The individual development environment is the compilation of all the components necessary to generate the control software, such as libraries or library components or their equivalents, drivers for controlling specific process or automation components, e.g., network connections, communication interfaces, etc., and a transformation program, which is provided as a compiler, interpreter, etc. to generate the control software executable on a target hardware.

Preferably, the device according to the exemplary, non-liming embodiment of the present invention may further include a system configurator, which determines the configuration of the automation hardware using third data, e.g., hardware knowledge. Having a system configurator allows the automatic generation of automation software to be rounded out. In particular, first, the development environment is generated and then this development environment is used to generate the actual control software. This actual control software can then be executed directly if the configuration of the automation hardware is available.

### BRIEF DESCRIPTION OF THE FIGURES

The present invention will now be described in detail by describing illustrative, non-limiting embodiments thereof with reference to the accompanying drawings. In the drawings, the same reference characters denote the same or analogous elements:

FIG. 1 is a schematic representation of a generator for automatically generating automation software including the required data according to an exemplary non-limiting embodiment of the present invention,

FIG. 2 illustrates the individual process steps involved in the automatic generation of automation software according to another exemplary, non-limiting embodiment of the present invention, and

FIG. 3 shows a data flow diagram for the automatic generation of automation software according to another exemplary, non-limiting embodiment of the present invention.

### DETAILED DESCRIPTION OF ILLUSTRATIVE, NON-LIMITING EMBODIMENTS

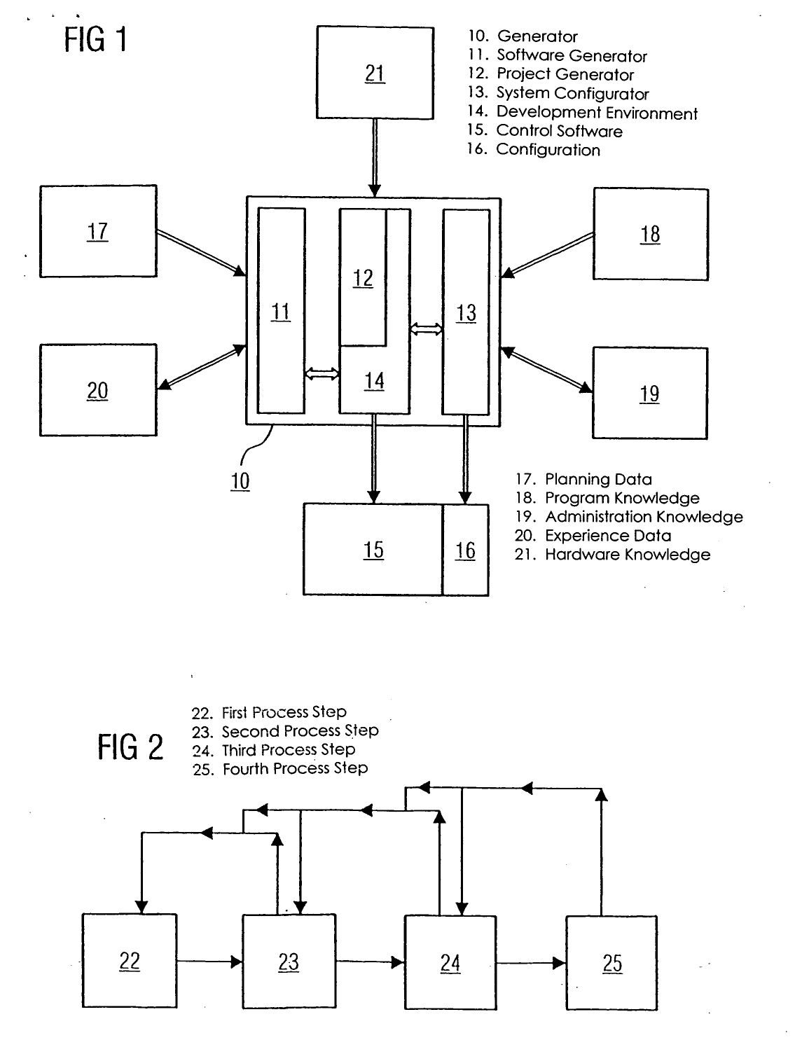

FIG. 1 is a schematic overview of a generator 10 with a software generator 11, a project generator 12, and a system configurator 13.

The software generator 11, depicted in FIG. 1, is provided to generate a development environment 14. The project generator 12, also depicted in FIG. 1, is provided to generate control software 15. The system configurator 13, also depicted in FIG. 1, is provided to determine a suitable configuration 16 for operation of the control software 15 on an automation hardware. The automation hardware (not depicted) comprises individual automation devices, e.g., a programmable controller or a process computer, or a combination of such devices. These exemplary individual devices may have decentralized peripheral interface connections and/or a master computer, e.g., with product planning functionalities. The system configurator 13 may also configure the automation hardware directly by transmitting the respective configuration 16, i.e., the configuration data, to the automation hardware. The control software 15 controls the automation hardware, and thereby, the control software 15 controls and/or monitors a technical process (not depicted), e.g., a welding line (automobile production or the like) or a roll stand (steel production).

The software generator 11 generates the development environment 14 using first data. The first data can be specified or may be a default data. The first data includes planning data 17, program knowledge 18, and administration knowledge 19. The planning data 17 includes, for example, design data. The design data may be processed or simply provided e.g., by a CAD (Computer Aided Design) system. The planning data 17 further includes a task description and/or a problem description and/or data regarding prior projects. The program knowledge 18 includes data relating to functions, e.g., capacity or availability, structures, versions and/or dependencies such as the dependencies of individual functions in relation to each other. The administration knowledge 19 includes data relating to usage management, billing and/or an updating service.

The software generator 11 analyzes available first data. For example, based on the design data, which may be included in the planning data 17, it is possible to determine characteristics of a technical process e.g., that the technical process uses frequency-controlled drives. These exemplary drives require special actuators, which in turn require special software for controlling these special actuators. The special software, which is thereby determined to be required, is a necessary component of the development environment 14 that will be automatically generated.

Based on the task or problem description, particularly in conjunction with data on prior projects, all of which may also be included in the planning data 17, further components necessary for the development environment 14 can be determined. These further necessary components may also be determined based on partial tasks or partial problems, if applicable taking into account the handling of the prior projects.

For each component that is necessary for the development environment 14, the program knowledge 18 determines what further components, e.g., software modules, libraries or the like, are necessary for the development environment 14. For example, to determine what further components are needed, data regarding the function range or data regarding structures are accessed by the program knowledge 18. Frequently, a component that is necessary for the development environment 14 requires further components (additional components) because of dependencies, e.g., import relationships, between the required component and the one or each further component. For example, to obtain the additional components, data on dependencies or data on structures are accessed.

Furthermore, the compatibility between components in the development environment 14 must be ensured. For example, to ensure the compatibility of a component that is to be included in the development environment 14, data regarding versions and/or dependencies is accessed. Finally, the generator 10 must ensure that each of the required components is available and is current (the latest version of this component). To ensure that the required component is current and is available, access to data relating to usage management and/or data relating to an updating service is provided. Moreover, to enable billing for the used components or billing for the use of the components, access to billing data must be provided. Accordingly, based on all of the available first data, a development environment 14 specifically adapted to the corresponding task or problem is automatically generated.

The project generator 12 generates the control software 15 from a second data using the generated development environment 14. The second data may be specified or may be a default data. The second data includes planning data 17, experience data 20, and hardware knowledge 21. Using the planning data 17, particularly, task and problem descriptions, possibly in conjunction with data on prior projects, a structure of the control software 15 is determined. The structure is determined with respect to the required functions and a sequence for calling such functions. The more detailed the data on prior projects, the more comprehensively the determined structures can be filled in with program instructions. If these program instructions cannot be automatically generated, the control software 15 may at least be supplemented with information, e.g., in the form of comment lines, which inform a programmer later revising the control software as to what operations should be provided at a specific point of the control software 15.

The experience data 20 includes, for example, data relating to expert knowledge or knowledge from specific industry branches. This experience data 20 can also take current trends into account. This data is used, for example, to automatically determine that a certain device needs to be provided, i.e., to automatically determine that explosion-proof field devices or field devices having a particular protection class for instance IP65, must be provided in critical industrial environments. These field devices are specialized solutions for the specific providers as opposed to standard field devices. While standard field devices would be available, e.g., with a channel granularity of 1 or 2 bits (digital I/O), specialized field devices would generally be available only in a few configurations, e.g., 8-bit and 16-bit (digital I/O). In other words, if industry or expert knowledge is considered, a different field device configuration may result than if this information were ignored or disregarded. If one or more specialized field devices with eight digital input/output channels is determined to be required, then a corresponding control software 15 that controls these specialized field devices would also have to be adopted.

In addition or as an alternative, the experience data 20 may also include a manufacturer library e.g., a manufacturer library with sample solutions. These sample solutions make it possible to fill in automatically generated structures of the control software 15 with suitable program instructions, thereby ensuring proper operation, e.g., the correct operation of a specific field device.

Furthermore, the experience data 20 may also include an experience database. An experience database may provide information on whether a specific, possibly automatically generated, automation software had proven suitable in a comparable or partial problem, or a comparable or partial task. This information makes it possible to distinguish suitable solutions from unsuitable or less suitable solutions in an evolutionary strategy. For the corresponding control software 15, solutions recognized as suitable are preferably analyzed for their applicability.

The experience data 20 is continuously updated, since every generated control software 15 supplies new experience data 20, which may be useful in subsequent projects.

Individual program instructions in the control software 15 relate to the control of the automation hardware. To ensure correct control of the automation hardware or of individual automation components of the automation hardware, e.g., input/output modules for inputting data from the technical process or for transmitting control information to the technical process, the second data also includes hardware knowledge 21. The hardware knowledge 21 can be used, for example, to determine what measures are required to activate a specific output of a specific field device of the automation hardware. This hardware knowledge 21 makes it possible to automatically generate the corresponding program instructions for the control software 15, e.g., to activate a third output of a field device. A field device is typically connected via a field bus to a central automation device, e.g., a programmable controller. Based on the hardware knowledge 21 it is also possible to automatically generate for the control software 15 the program instructions that are required to operate the transmission protocol for the respectively used field bus.

The system configurator 13 automatically generates the configuration 16 by means of third data, e.g., hardware knowledge 21. When the control software 15 is generated, the type and scope of the required automation hardware is determined. Accordingly, for example, the capacity, e.g., the processing speed or memory capacity, required for a central automation device is known. Thus, catalog data, even perhaps representing multiple manufacturers, and which form part of the hardware knowledge 21, can be used to determine which automation device meets these requirements.

After determining the specific automation device in the manner described above, other hardware knowledge 21 can be used to determine how and to what extent the automation device can be configured. Based on the requirements of the control software 15, the required corresponding configuration 16 can be established and possibly automatically transmitted in a suitable form to the automation device.

Similarly, the type and scope of the required automation hardware also indicates, for example, whether and how the individual automation devices are interconnected by a field bus. Based on the projected data volume, which can be determined by means of the control software 15, a data transmission rate is obtained for the field bus. The data transmission rate may influence the protocol that can be used. The determined configuration data with respect to the protocol and the data transmission rate also flow into the configuration 16. Thus, the transmission of the configuration 16 to the respective devices of the automation hardware also includes the configuration of each automation device that is connected to the field bus.

After implementing all or some of these exemplary steps, automatically generated automation software is available. This automation software includes the development environment 14, the control software 15, and possibly the configuration 16. The first data influences the automatic generation of the development environment 14. The second data and the development environment 14 influence the automatic generation of the control software 15. The third data and the control software 15 influence the automatic generation of the configuration 16.

Hence, any change in the first data affects the development environment 14 and therefore, at least indirectly, the control software 15 and the configuration 16. Similarly, any changes in the second data affects the control software 15 and, at least indirectly, the configuration 16. Finally, any change in the third data affects the configuration 16. A change in the first, second, or third data can be, for example, a change in the scope and/or availability of the corresponding data as well as an update of the corresponding data. Of course, these changes have an effect on the automatically generated automation software only if the changes relate to the data that has been or can be used in the automatic generation of the automation software.

Overall these exemplary steps result in an iterative process in the automatic generation of automation software, which is illustrated in FIG. 2. The first, second and third data that are, or can be, used are determined in a first process step 22. This first process step 22 includes a manual specification, e.g., of the planning data 17 with a description of the technical process to be automated. In addition, or as an alternative, the planning data may include importation of data or means for importing this data. For example, the generator or a processor can serve as means for importing the data. Finally, the first process step 22 may also include the selection or determination of an interface for importation through which the first, second, or third data can be imported.

A second process step 23 includes the automatic generation of the development environment 14, the control software 15, and possibly the configuration 16. A third process step 24 includes the processing and expansion of the control software 15 by using the development environment 14. In a fourth process step 25, the generated automation software, i.e., the control software 15 and possibly the configuration 16, are transmitted to the automation hardware.

A user can make changes in each of the process steps 22-24, and thereafter automatically regenerate the automation software. The user executes the individual process steps and any required adaptations or expansions until the finished automation software is available. The more comprehensive the first, second, and third data are, the more detailed is the automation software automatically generated by the generator 10. The user completes any components or sequences of the automation software that cannot be automatically generated in the third process step 24. To the extent possible, the user is supported through comments that are automatically inserted in the control software 15 in place of the sequences that cannot be automatically generated. These comments include information on the functionality of the sequence that cannot be automatically generated and preferably information on the data that should be used for generating this functionality of the sequence.

The generator 10 generates individually adapted automation software. If new functions are needed, for example, the generated automation software is automatically updated. In other words, this new function is available in the development environment 14 and, if applicable, becomes part of the generated control software 15. Thus, the user is relieved from administrative tasks related to software projects and libraries. The data, i.e., for example, the functions that were required to automatically generate the automation software, are determined as additional information.

As a result, any license fees can be calculated specifically based on the service actually used. The automation software provider, e.g., a provider of development environments to generate automation software, thereby, avoids the need to provide and support various software packages with different capabilities and functions and often also different versions because the automation software and the corresponding development environment are generated individually based on the concrete requirements of the user.

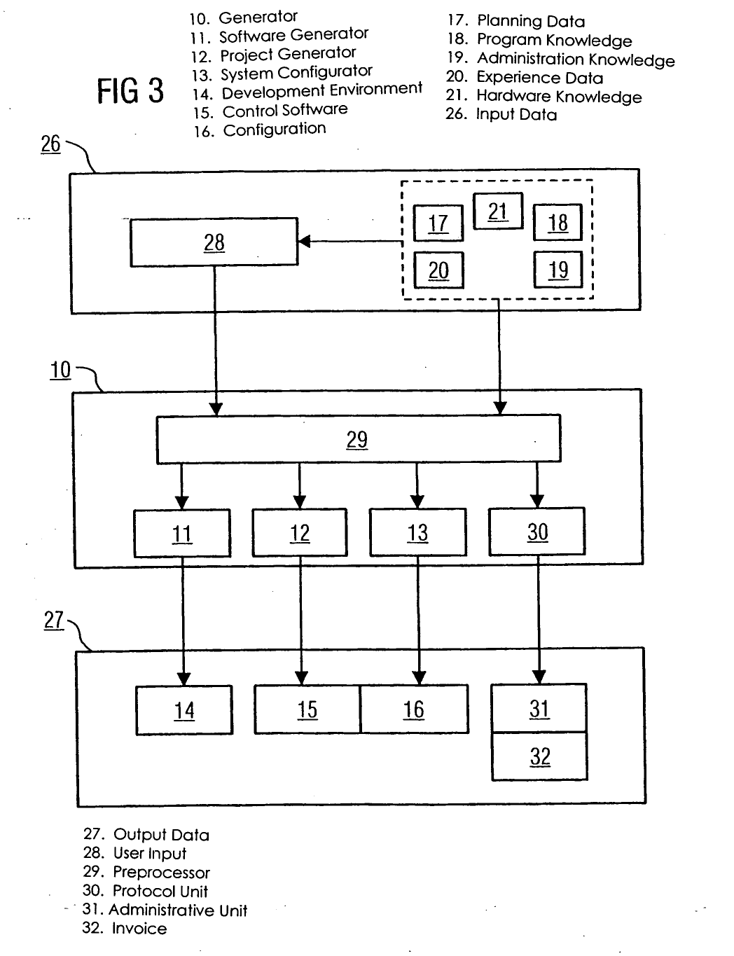

FIG. 3 shows a data flow diagram for the automatic generation of automation software. Similarly to FIG. 1, this figure shows the generator 10 with the software generator 11, the project generator 12, and the system configurator 13. The generator 10 processes input data 26 and generates output data 27. The input data 26 include the first, second, and third data. The first data includes the planning data 17, the program knowledge 18, and the administration knowledge 19. The second data includes the planning data 17, the experience data 20, and the hardware knowledge 21. The third data includes at least the hardware knowledge 21.

The software generator 11 generates the development environment 14 using the first data. The project generator 12 generates the control software 15 using the second data and the development environment 14. Finally, the system configurator 13 generates the configuration 16 of the corresponding automation hardware using the third data. The first, second, or third data can be a default data or it can be specified.

The user influences the automatic generation of automation software by, on the one hand, providing and completing suitable first, second, and third data and, on the other hand, by providing user input 28, i.e., manual additions or modifications in each or some of the process step 22-25, (FIG. 2).

A preprocessor or a preprocessing unit 29 is provided for the generator 10 to process the input data 26. This preprocessor makes it possible to import the first, second, or third data either by operating a defined interface to access these data or by converting the data into a format suitable for further processing, e.g., by the software generator 11 or the project generator 12.

Further, the preprocessing unit 29 also considers default rules or specified rules. Accordingly, changeable or expandable rules of a rule database (not depicted) are considered in processing the input data 26. With the aid of these rules, which are automatically selected and applied as needed, the first, second, and third data can be analyzed and evaluated.

One of these rules states for example,: “If decentralized field devices are provided or required, a field bus connection must be provided between one or each decentralized field device and a central automation device.” Further rules may relate, for example, to the type of the field bus connection, e.g., to the maximum data throughput. Other rules can influence, for example, the use of safety-related automation devices. The rule related to the safety-related automation device might be, e.g., “In continuous, particularly uninterruptible processes, safety-related or failure-tolerant automation components must be provided.” Such a rule is an example of an expandable rule in which the user can specify, e.g., that “a chemical process for refining crude oil is a continuous uninterruptible process.” Whether the corresponding technical process is a process for refining crude oil is indicated by the first data, particularly by the planning data, e.g., by the task or problem description.

The automatic processing of the first, second, and third data, the determination of mutual relationships, the selection of appropriate rules, etc. are facilitated if all of the data are provided with standardized identifiers to identify each particular data. The format of such identifiers preferably follows existing or emerging standards. For example, W3C (WWW Consortium; WWW=World Wide Web) has specified WebServices, i.e., services offered on, or downloadable from the Internet regarding the message format and the message exchange, directory services to store service descriptions (Universal Description, Discovery, and Integration, “UDDI”) and a language for service description (Web Services Description Language, “WSDL”).

Specifications of this type may also be used to identify and assign the first, second, and third data.

For example, within the planning data 17, data on prior projects may be assigned identifiers that indicate the software functions used to configure individual components or sequences. If these components or sequences are subsequently considered for reuse in a new control software 15, the identifiers can be used to automatically determine the functionality that must be available, e.g., in the development environment 14, to handle the components or sequences that can be adopted in the new control software 15.

A further example of the use of standardized identifiers to identify and assign data and information for automatically generating automation software relates to the planning data 17 and, more particularly, to a design data, e.g., data supplied by a CAD program, and hardware knowledge 21, e.g., catalog data. If design data is provided with unique, informative identifiers, e.g., regarding the use and functionality of the individual devices such as motors, valves and sensors, probes, photoelectric barriers, etc., then catalog data, or even prior projects can be searched for the corresponding characteristics of these individual devices, and specific selections can be made.

Identifiers of the above-described type may relate, for example, to the following:
industry, field of application, product,
production principle (conveyor belt, pipes, etc.),
project structuring (technological, functional, CPU-oriented, etc.),
programming language or programming method (flow-oriented, continuous, ladder diagram, sequential function chart),
control algorithm, control parameter,
partial processes (conveyor belt control, mixing, heating, pressing, bending, etc.).
   Identifiers may also relate to other items. Identifiers relating to other items are clearly within the scope of the invention.

All of the required data are provided to the generator 10 via standard interfaces and standard networks. For example, ebXML (the extensible declarative language) may be used for a standard interface. ebXML is provided for handling business processes over the Internet. There are specifications regarding message formats and message exchanges, a registry and a repository service and templates for business-specific objects and processes. Message transport in WebServices and meanwhile also ebXML is based on the Simple Object Access Protocol (SOAP), an XML-based protocol for a remote procedure call (RPC) or message-oriented communication, which is typically encapsulated in HTTP ensures reliable communication.

W3C has specified Web services with respect to the message format and exchange, directory services for storing service descriptions (UDDI) and a language for service description (WSDL).

After the components that are required for the development environment 14 and/or the control software 15 have been identified, the first, second, and third data are searched to find these components in these first, second, and third data. Accordingly, suitable components are selected for use. A prerequisite for their usability is a fine modular structure of the software and the individual components enabling their combination via predefined interfaces.

For the further generation of the control software 15, previous projects are accessed among the planning data 17. The selection among a plurality of previous projects is made to obtain the greatest possible correspondence with the respective specific requirements. Components or sequences that can be adopted from previous projects form the basis of the automation software to be generated. This basis is supplemented by suitable components determined from other past projects, manufacturer libraries, catalogs, etc.

The control software 15 may consist of individual programs that can be generated and executed independently. For the common control of a technical process, communication between these basically independent programs is required. Possible communication paths between individual programs are determined via the planning data 17 and are established via standard mechanisms (.net, Ethernet, etc.).

The generator 10 also includes a protocol unit 30 for recording the data used. The recorded data also includes data regarding one or more software components used and information as to whether the corresponding (additional) software component was used in generating the development environment 14 or the control software 15. The recorded data makes it possible to generate an invoice for the components used. That is, after access to an administration system 31, an invoice 32 can be generated for the user. This invoice 32 accounts for the data used. The administration system 31 may be provided on a central server, particularly one that can be reached via the Internet, for example.

Thus, the exemplary embodiments of the present invention may be described as follows:

The exemplary, non-limiting embodiments depart from rigid programs and libraries and a subsequent input of data to solve a problem. Instead, suitable data or access to such data is provided: to automatically generate, first, an individual development environment 14 based on the concrete automation problem and then, using this development environment 14, to automatically generate the actual control software 15. To automatically generate the software, information on planning tools, etc., libraries and/or previous projects are accessed by means of the Internet and standardized program or data interfaces, e.g., XML. Heretofore such information was only locally stored. The general conditions of the corresponding automation project form the basis of the individual elements of the automation software that are to be automatically generated, i.e., the actual control program 15, possibly an additional HMI program and possibly a system configuration 16.

The above description of illustrative, non-limiting embodiments has been given by way of an example. The above and other features of the invention including various novel method steps and a system and a device of the various novel components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope of the invention as defined by the appended claims and equivalents thereof.

1. A device for automatically generating automation software, the device comprising:
a generator comprising at least one software generator and a project generator,
wherein the at least one software generator generates a development environment using first data, and
wherein the project generator generates control software using the generated development environment and second data.

2. The device as claimed in claim 1, wherein the generator further comprises a system configurator and wherein the system configurator determines configuration of automation hardware using third data.

3. The device as claimed in claim 2, wherein the first data comprises at least one of planning data, program knowledge and administration knowledge.

4. The device as claimed in claim 2, wherein the second data comprises at least one of planning data, experience data and hardware knowledge.

5. The device as claimed in claim 2, wherein the third data comprises hardware knowledge.

6. The device as claimed in claim 2, wherein the control software comprises a human machine interface.

7. The device as claimed in claim 1, wherein the first data comprises at least one of planning data, program knowledge and administration knowledge.

8. The device as claimed in claim 1, wherein the second data comprises at least one of planning data, experience data and the hardware knowledge.

9. The device as claimed in claim 1, wherein the control software comprises a human machine interface.

10. A method for automatically generating automation software using a generator that comprises at least one software generator and a project generator, the method comprising:
generating, via the software generator, a development environment using first data, and
generating, via the project generator, control software using the development environment and second data.

11. The method as claimed in claim 10, wherein the generator further comprises a system configurator and wherein the system configurator effects a configuration of automation hardware using third data.

12. The method as claimed in claim 11, wherein the first data comprises at least one of planning data, program knowledge and administration knowledge.

13. The method as claimed in claim 11, wherein the second data comprises at least one of planning data, experience data and hardware knowledge.

14. The method as claimed in claim 11, wherein the third data comprises hardware knowledge.

15. The method claimed in claim 11, wherein the control software comprises a human machine interface.

16. The method as claimed in claim 10, wherein the first data comprises at least one of planning data, program knowledge and administration knowledge.

17. The method as claimed in claim 10, wherein the second data comprises at least one of planning data, experience data and hardware knowledge.

18. The method claimed in claim 11, wherein the control software comprises a human machine interface.

19. A system for automatically generating automation software, comprising:
a preprocessor processing input data and data specified in a data store, the specified data comprising first data and second data;
a software generator generating a development environment based on the first data received from the preprocessor; and
a project generator generating a control software based on the development environment generated by the software generator and the second data received from the preprocessor.

20. The system as claimed in claim 19, wherein said input data comprises manual additions and modifications made by the user in at least one of the data specified in the data store and the development environment.

21. The system as claimed in claim 19, wherein the specified data further comprises third data, and the system further comprises a system configurator generating a configuration of automation hardware based on the third data and the control software generated by the project generator.

22. The system as claimed in claim 21, wherein the first data comprises planning data, program knowledge, and administration knowledge, wherein the second data comprises planning data, experience data and hardware knowledge, and wherein the third data comprises the hardware knowledge.

23. The system as claimed in claim 22, wherein the first data, the second data, and the third data is provided with standardized identifiers identifying each item of data from the first, second, and third data, and wherein the identifiers are used in searching the first, second, and third data by the preprocessor.

24. The system as claimed in claim 23, wherein the identifiers relate to at least one of an industry, field of application, a product, a production principle, project structuring, programming method, control algorithm, and processes performed by the automation hardware.

25. The system as claimed in claim 21, wherein when the planning data comprises data on prior projects related to a control software to be generated, the generated control software is at least partially filled in with program instructions and wherein when no data on the prior projects related to the control software to be generated is provided, the generated control software is supplemented with comment lines describing operations to be provided at a specific point of the control software.

26. The system as claimed in claim 19, further comprising a protocol unit recording components being used in the control software and the development environment, accessing an administration unit and generating a bill for the use of the recorded components.
